(19) United States
(12) Patent Application Publication
(10) Pub. No.: US 2017/0143163 A1
(43) Pub. Date: May 25, 2017

(54) COOKING PAN

(71) Applicant: KE M.O. HOUSE CO. LTD., Shenzhen (CN)

(72) Inventor: Mo-Tsan Tsai, Shenzhen (CN)

(21) Appl. No.: 15/060,228

(22) Filed: Mar. 3, 2016

(30) Foreign Application Priority Data
Nov. 25, 2015 (CN) 201520950986.9

(51) Int. Cl. A47J 37/10; B65D 25/04; A47J 45/06

(52) U.S. Cl. CPC A47J 37/108; A47J 45/061; B65D 25/04

(57) ABSTRACT

A cooking pan comprises a pan body used for cooking food. The pan body includes three parts, namely bottom, side extending upwardly from the bottom all around and partition disposed on the bottom and combining with the side to divide the pan body into at least two cooking zones which respectively have differently-shaped bottom walls. The at least two cooking zones and their respective differently-shaped bottom walls can work together to process different types of food, thus contributing to diverse functions and higher food processing efficiency of the cooking pan.

### TECHNICAL FIELD

The present application relates to a cooking utensil, and particularly to a cooking pan.

### DESCRIPTION OF THE RELATED ART

Cooking is the art of preparing and processing food to make it more delicious, good-looking and smell better. Good food is featured with attractive color, smell, taste and shape, not only making people feel more contented when enjoying the food, but also allowing the nutrition of the food to be more easily absorbed by human body.

In addition to food materials, cooking utensils are indispensable for cooking. Good cooking utensils have great effects on the color, smell and taste of food. Cooking pans are commonly-used cooking utensils, including saute pans and flying pans and the like. Different types of cooking pans vary in functions and the users have to select appropriate cooking pans to adapt to their specific needs.

For example, a flying pan is mainly used to fly a variety of food, such as eggs, fish and beefsteak. In actual use, different types of food have different requirements on the bottom wall of the flying pan; however, the prior-art flying pans basically have just one type of bottom wall, causing their functions to be relatively simple.

### SUMMARY OF THE INVENTION

The present application is directed to a novel type of cooking pan.

A cooking pan comprises a pan body used for cooking food. The pan body includes three parts, namely bottom, side extending upwardly from the bottom all around and partition disposed on the bottom and combining with the side to divide the pan body into at least two cooking zones which respectively have differently-shaped bottom walls.

As an improvement to the said cooking pan, the bottom wall of at least one cooking zone is provided with a depressed oil collection chamber.

As an improvement to the said cooking pan, the above-mentioned oil collection chamber comprises an oil guide groove and an oil storage groove connected with the oil guide groove. The oil storage groove is disposed at a corner of the cooking zone.

As an improvement to the said cooking pan, the oil storage groove is deeper than the oil guide groove.

As an improvement to the said cooking pan, the partition is cross-like and divides the pan body into four cooking zones. The cooking zones consist of the first cooking zone with a flat bottom wall, the second cooking zone having a bottom wall with a depressed cavity, the third cooking zone having a bottom wall with projected points and the fourth cooking zone having a bottom wall with ribbed strips.

As an improvement to the said cooking pan, the third cooking zone and/or the four cooking zone is provided with an oil collection chamber.

As an improvement to the said cooking pan, the cooking pan further comprises a handle. The pan body is provided with an attachment connected with the handle and the handle is removable from the attachment.

As an improvement to the said cooking pan, two attachments are provided, which are respectively disposed on two opposite side walls of the pan body.

As an improvement to the said cooking pan, the handle comprises a long handle and a short handle, either of which is removable from the attachment.

As an improvement to the said cooking pan, the cooking pan is a flying pan.

The advantageous effects of the present application are as follows:

The cooking pan disclosed herein comprises a pan body used for cooking food. The pan body includes three parts, namely bottom, side extending upwardly from the bottom all around and partition disposed on the bottom and combining with the side to divide the pan body into at least two cooking zones which respectively have differently-shaped bottom walls. The at least two cooking zones and their respective bottom walls can work together to process different types of food, thus contributing to diverse functions and higher food processing efficiency of the cooking pan.

Further, according to the present application, the bottom wall of at least one cooking zone is provided with a depressed oil collection chamber which serves to collect oil mostly produced by the food from the cooking zone during cooking, especially when meat, such as fish and beefsteak, is fried. The resulting oil can flow into the oil collection chamber such that the fried food contains less oil and is hence more green, nutritive and healthy.

### BRIEF DESCRIPTION OF THE DRAWINGS

FIG. 1 is a perspective view of a cooking pan embodying the invention;

FIG. 2 is a schematic front view of the embodiment shown in FIG. 1;

FIG. 3 is a schematic view of replacing a handle of the embodiment shown in FIG. 1; and

FIG. 4 is a schematic view of the embodiment shown in FIG. 1 installed with a short handle.

### DETAILED DESCRIPTION OF PREFERRED EMBODIMENT

The embodiment of the present invention will now be described with reference to the drawings. The present application may be embodied in a variety of forms and is not limited to the embodiment described herein. The following specific embodiment is presented to aid in more clear and thorough understanding of the present application. The terms “upper”, “lower”, “left” and “right” shall only relate to the shown structure as oriented in the corresponding figures.

However, those skilled in the art may appreciate that the description of one or more specific details may be omitted or other methods, components or materials may be employed. In some examples, some embodiments are not described or not described in detail.

Moreover, the technical features and technical solutions described herein may be combined in any appropriate way to produce one or more embodiments.

The present application relates to a cooking pan comprising a pan body used for cooking food. The pan body includes three parts, namely bottom, side extending upwardly from the bottom all around and partition disposed on the bottom and combining with the side to divide the pan body into at least two cooking zones which respectively have differently-shaped bottom walls. The at least two cooking zones and their respective bottom walls can work together to process different types of food, thus contributing to diverse functions and higher food processing efficiency of the cooking pan.

The following embodiment describes the present application by taking a flying pan for an example for ease of understanding. Of course, in addition to a flying pan, the cooking pan disclosed herein may be a flying pan and the like.

### Embodiment 1

Embodiment 1 provides a cooking pan, especially a frying pan.

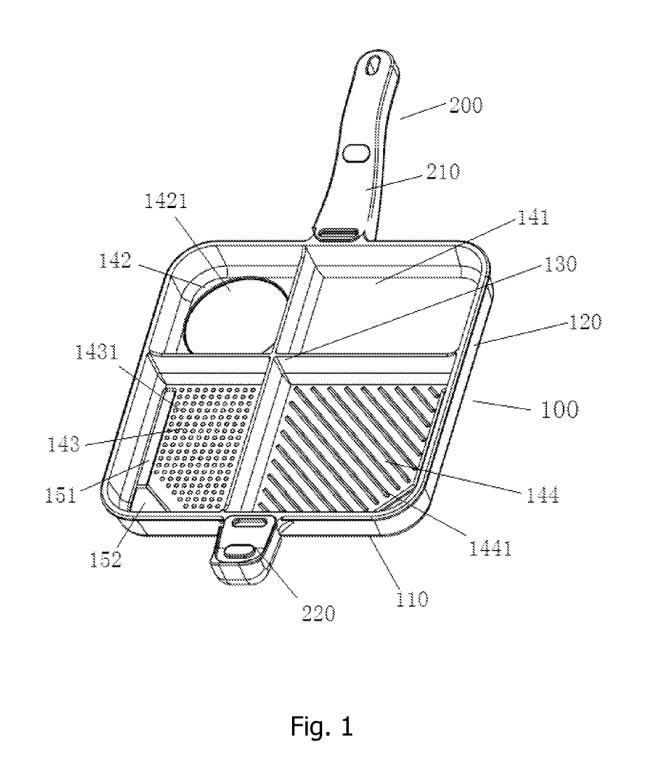

As shown in FIG. 1, the flying pan comprises a pan body 100 used for cooking food. The pan body 100 includes three parts, namely bottom 110, side 120 extending upwardly from the bottom 100 all around to enclose a chamber for flying food and partition 130.

The partition 130 is disposed on the bottom 110 and combines with the side 120 to divide the pan body 110 into at least two cooking zones which respectively have differently-shaped bottom walls.

The separated cooking zones and differently-shaped bottom walls allow the user to process different types of food simultaneously, thereby greatly improving the cooking efficiency.

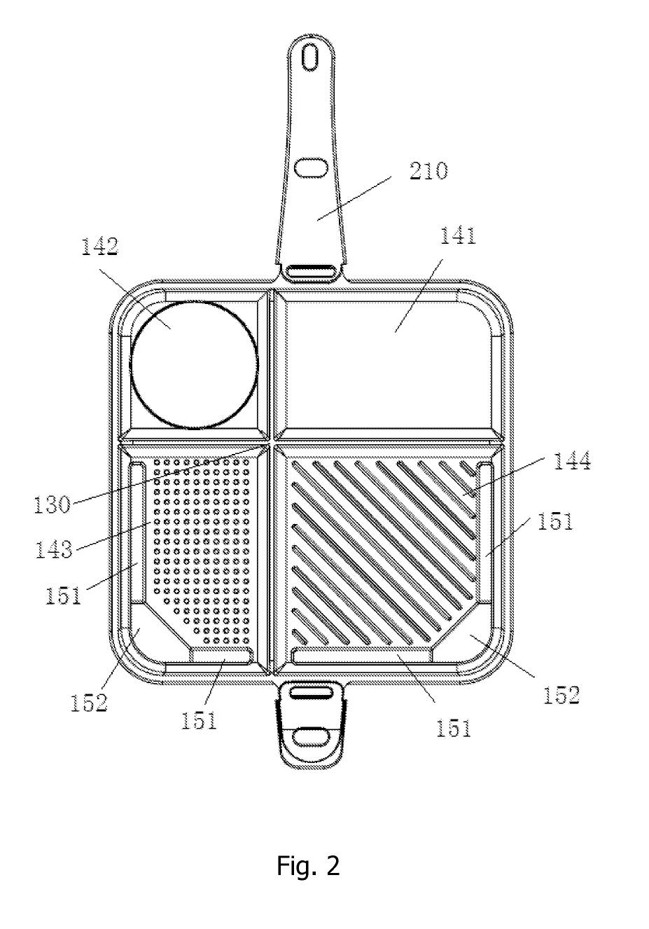

As shown in FIG. 1 and FIG. 2, the partition 130 in this embodiment is cross-like and divides the pan body 100 into four cooking zones.

The cooking zones consist of the first cooking zone 141 with a flat bottom wall, the second cooking zone 142 having a bottom wall with a depressed cavity 1421, the third cooking zone 143 having a bottom wall with projected points 1431 and the fourth cooking zone 144 having a bottom wall with ribbed strips 1441.

Such cooking zones are divided in accordance with commonly-used fried food materials. The first cooking zone 141 with a flat bottom wall is applicable to flying ordinary food materials and can even be used for cooking vegetables or for other purposes. The second cooking zone 142 having a bottom wall with a depressed cavity 1421 is applicable to cooking fried eggs and the like. The third cooking zone 143 having a bottom wall with projected points 1431 is applicable to cooking fried fish and the like. The fourth cooking zone 144 having a bottom wall with ribbed strips 1441 is applicable to cooking fried beefsteak and the like.

The cooking zones are divided above simply according to the commonly-used fried food materials. Certainly, in other embodiments, they may also be divided according to other special food materials, and the bottom walls of the cooking zones may be designed flexibly to adapt to the special food materials.

The above quantity of the cooking zones is just illustrated for example. In other embodiments, the designed quantity of the cooking zones may be two, three or even more.

Further, excessive oil quantity may potentially occur in some cooking zones during cooking; therefore, the bottom wall of at least one cooking zone may be provided with a depressed oil collection chamber. The oil collection chamber can not only collect residual oil in the cooking zone which is treated centrally after the cooking is ended, but also allow the oil originating from the fried food (e.g., fried fish, fried beefsteak and the like) to flow into the oil collection chamber such that the fried food contains less oil and is hence more green, nutritive and healthy.

Further, as shown in FIG. 1 and FIG. 2, the illustrated oil collection chamber disclosed in this embodiment comprises an oil guide groove 151 and an oil storage groove 152 connected with the oil guide groove 151. The oil storage groove 152 is disposed at a corner of the cooking zone.

The above design is advantageous in that the oil guide groove 151 is disposed at the edge of the cooking zone and will not impede flying operation in the cooking zone; moreover, the oil storage groove 152 is disposed at a corner of the cooking zone, which allows the oil fluid to be readily dumped after the cooking is ended.

Certainly, the oil storage groove 152 may further be designed to be deeper than the oil guide groove 151 so as to store more oil fluid. Alternatively, in other embodiments, the oil storage groove 152 may be designed as deep as the oil guide groove 151.

In this embodiment, as the third cooking zone 143 and the fourth cooking zone 144 are used to cook fried fish and fried beefsteak, an oil collection chamber is disposed in the third cooking zone 143 and/or the fourth cooking zone 144 to collect the oil resulting from cooking of fried fish and beefsteak.

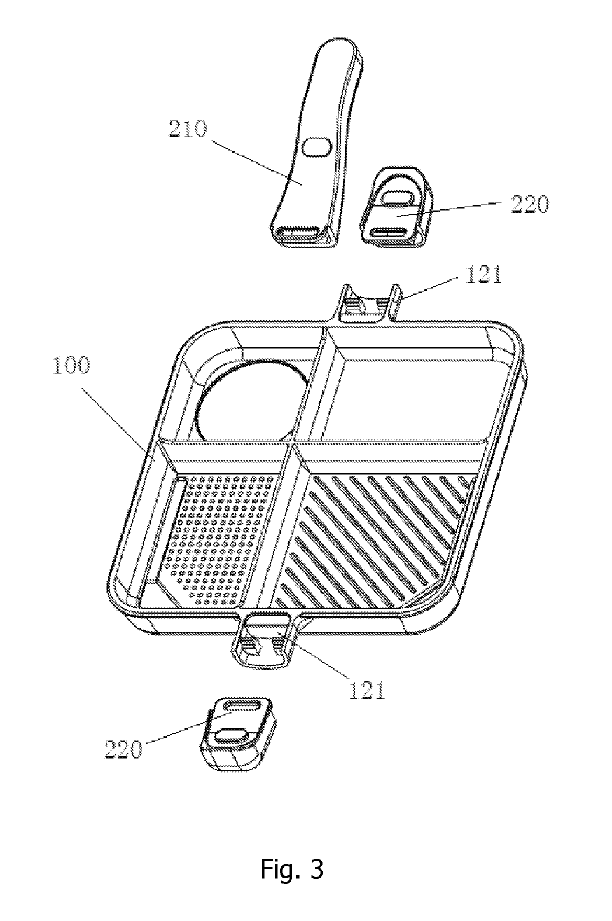

Further, as shown in FIG. 3, the cooking pan comprises a handle 200 for good portability. An attachment 121 connected with the handle 200 is provided on the pan body 100. The handle 200 is removable from the attachment 121 to allow for replacement of the handle 200.

Further, as shown in FIG. 3, two attachments are provided, which are respectively disposed on two opposite side portions of the pan body. Of course, more than two handles 200 may be provided such that the user can hold the pan body 100 with both hands easily.

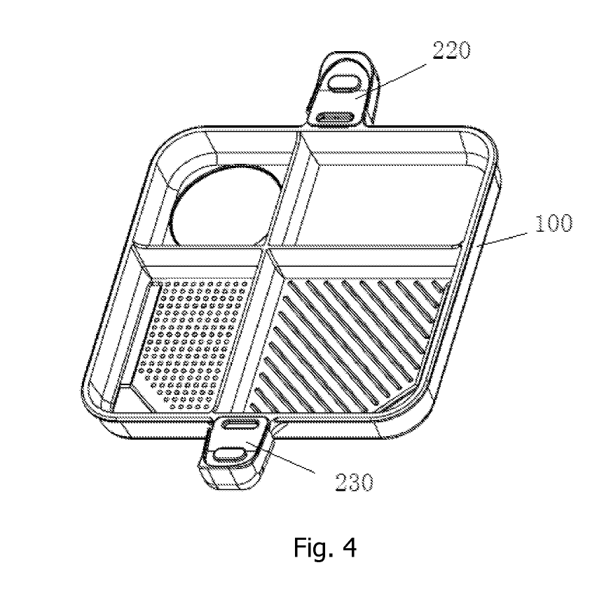

Further, as shown in FIG. 3 and FIG. 4, the handle 200 comprises a long handle 210 and a short handle 220. The quantity of the long handle 210 may be one and the quantity of the short handle 220 may be two. Both the long handle 210 and the short handle 220 are removable from the attachment 121. Such design is advantageous in that, during cooking, the long handle 210 is fastened to the attachment 121, as shown in FIG. 1 and FIG. 2, to allow the user to perform cooking operation; after the cooking operation is ended, the long handle 210 is removed and replaced with the short handle 220, as shown in FIG. 4, such that the user can serve the entire pan body 100 to the dining table by directly holding the short handle 220 which presents a good look.

The removability of the handle 200 from the attachment 121 may be achieved by an elastic snapping structure or other structures. Specifically, a button 200 is disposed on the handle 200. Once the button 200 is pressed down, the handle 200 can be removed off conveniently and rapidly.

The above embodiment is just a detailed description of the invention; certainly, the invention is not solely limited to the above embodiment. Any derivations or modifications, obvious to those skilled in the art, can be made thereto without departing from the concept of the present invention.

1. A cooking pan comprising a pan body used for cooking food with the pan body including three parts, namely bottom, side extending upwardly from the bottom all around and partition disposed on the bottom and combining with the side to divide the pan body into at least two cooking zones which respectively have differently-shaped bottom walls.

2. The cooking pan as claimed in claim 1, wherein the bottom wall of at least one cooking zone is provided with a depressed oil collection chamber.

3. The cooking pan as claimed in claim 2, wherein the oil collection chamber comprises an oil guide groove disposed along the edge of the cooking zone and an oil storage groove connected with the oil guide groove, and the oil storage groove is disposed at a corner of the cooking zone.

4. The cooking pan as claimed in claim 3, wherein the oil storage groove is deeper than the oil guide groove.

5. The cooking pan as claimed in claim 2, wherein the partition is cross-like and divides the pan body into four cooking zones, namely the first cooking zone with a flat bottom wall, the second cooking zone having a bottom wall with a depressed cavity, the third cooking zone having a bottom wall with projected points and the fourth cooking zone having a bottom wall with ribbed strips.

6. The cooking pan as claimed in claim 5, wherein the third cooking zone and/or the four cooking zone is provided with an oil collection chamber.

7. The cooking pan as claimed in claim 1, wherein the cooking pan further comprises a handle, the pan body is provided with an attachment which is connected with the handle and the handle is removable from the attachment.

8. The cooking pan as claimed in claim 7, wherein two attachments are provided, which are respectively disposed on two opposite side walls of the pan body.

9. The cooking pan as claimed in claim 8, wherein the handle comprises a long handle and a short handle, either of which is removable from the attachment.

10. The cooking pan as claimed in claim 1, wherein the cooking pan is a flying pan.
